(19) United States
(12) Patent Application Publication
(10) Pub. No.: US 2011/0148911 A1
(43) Pub. Date: Jun. 23, 2011

(54) IMAGE PROCESSING CIRCUIT

(75) Inventors: Koji Yamasaki, Kyoto (JP); Kiyoshi Ichihara, Kyoto (JP)

(73) Assignee: Rohm Co., Ltd., Kyoto (JP)

(21) Appl. No.: 12/967,315

(22) Filed: Dec. 14, 2010

(30) Foreign Application Priority Data
Dec. 17, 2009 (JP) 2009-285856

(51) Int. Cl. G09G 5/02

(52) U.S. Cl. 345/601

(57) ABSTRACT

The image processing circuit 400 is provided with R RAM 418, G RAM 420, and B RAM 422. During the vertical blanking interval of a display device 122, tone correction results corresponding to all values which can be inputted as the input signal Di are stored as a lookup table (LUT) in each RAM. When an image is displayed in the display device 122, tone correction of the input signal Di is indirectly performed by referencing the LUT. Redundant computation can thereby be avoided, and power consumption can be reduced.

### CROSS-REFERENCE TO RELATED APPLICATIONS

This application is based on Japanese Patent Application No. 2009-285856 filed on Dec. 17, 2009, the contents of which are hereby incorporated by reference.

### BACKGROUND OF THE INVENTION

1. Field of the Invention

The present invention relates to an image processing circuit.

2. Description of Related Art

Image processing circuits for tone correction of an inputted image signal according to the characteristics of a display device or the preference of a user have been used in the past in cathode ray tube display devices, liquid crystal display devices, and other fields.

Typical methods for tone correction include gamma correction, contrast adjustment, brightness adjustment, and the like, and multiple types of these corrections are usually combined for tone correction of image signals.

FIG. 11 is a block diagram showing a conventional image processing circuit. The image processing circuit 900 is provided with a gamma correction unit 902, a contrast adjustment unit 904, a brightness adjustment unit 906, an input terminal 908, an output terminal 910, a first setting terminal 912, a second setting terminal 914, and a third setting terminal 916. An input signal Di inputted to the input terminal 908 is an RGB signal, for example.

The input signal Di inputted to the input terminal 908 is tone corrected by the gamma correction unit 902, the contrast adjustment unit 904, and the brightness adjustment unit 906, and outputted as an output signal Do from the output terminal 910. A gamma setting value A1 which is a setting value for tone correction by the gamma correction unit 902 is inputted from the first setting terminal 912, a contrast setting value A2 which is a setting value for tone correction by the contrast adjustment unit 904 is inputted from the second setting terminal 914, and a brightness setting value A3 which is a setting value for tone correction by the brightness adjustment unit 906 is inputted from the third setting terminal 916. The gamma correction unit 902, the contrast adjustment unit 904, and the brightness adjustment unit 906 apply computational processing to the input signal Di on the basis of the gamma setting value A1, the contrast setting value A2, and the brightness setting value A3, respectively, to apply tone correction to the input signal Di.

Japanese Laid-open Patent Publication No. 2001-75522 (referred to hereinafter as Patent Document 1) discloses a technical idea in which the gamma correction results corresponding to the gamma setting value set by a microcomputer are stored as an LUT (Lookup Table), and gamma correction of an input signal is performed by referencing the LUT during gamma correction of an input signal in the image processing circuit of a display device.

Japanese Laid-open Patent Publication No. 2002-51227 (referred to hereinafter as Patent Document 2) discloses a technical idea in which the R, G, and B values of an RGB input signal in an image processing circuit of a printer are each varied in sequence 16 levels at a time, each of R, G, and B starting from 0, in accordance with a gamma setting value, a contrast setting value, and other values set by a user to create 4,913 patches which are stored in an LUT format, and tone correction of an input signal is performed by referencing the LUT.

### SUMMARY OF THE INVENTION

In the image processing circuit 900 shown in FIG. 11, since the computational processing by the gamma correction unit 902, the contrast adjustment unit 904, and the brightness adjustment unit 906 is performed for each inputting of the input signal Di, computational processing is performed redundantly even when an input signal Di is inputted which is the same as a past input signal Di. Specifically, computational processing must be performed as many times as there are RGB values inputted to the image processing circuit.

Although Patent Document 1 discloses a technical idea whereby redundant computational processing is eliminated and power consumption of the image processing circuit is reduced by storing gamma correction results for an input signal as an LUT and gamma-correcting the input signal by referencing the LUT, Patent Document 1 does not disclose a technical idea of using an LUT to store the results of tone correction including contrast adjustment and brightness adjustment, which have the potential to be changed more often by the user.

Although Patent Document 2 discloses a technical idea whereby results of tone correction including gamma correction, contrast adjustment, and other correction are stored in an LUT, the LUT is created by sequentially varying the RGB values of an input signal 16 levels at a time, and Patent Document 2 does not disclose the technical idea of storing all patterns of an input signal as an LUT. Interpolation is therefore necessary when the LUT is referenced for tone correction of an input signal, and redundant computational processing is still performed.

The present invention overcomes these drawbacks, it being an object thereof to eliminate redundant computational processing and reduce power consumption by storing tone correction results in an LUT in an image processing circuit for performing tone correction of an input signal.

In the Specification, the high and low states of the vertical sync signal Tc, write signal Wr, R selection signal Dsr, G selection signal Dsg, and B selection signal Dsb are described as examples for the sake of convenience. The high and low states of these signals described are not limiting and may be reversed.

The present invention is an image processing circuit for performing tone correction of an input signal, the image processing circuit being characterized in comprising a signal generating unit for generating a dummy signal for creating a lookup table; a tone correction unit for receiving the dummy signal and performing tone correction of the dummy signal; and a storage device for receiving an output of the tone correction unit and storing the output as a lookup table; wherein the storage device receives the input signal, references the lookup table stored in the storage device, and performs tone correction of the input signal.

The image processing circuit according to another aspect of the present invention is a image processing circuit for performing tone correction of an input signal, wherein the input signal comprises a plurality of primary-color elements; and the image processing circuit comprises a plurality of storage devices in which a lookup table is stored for performing tone correction for each of the primary-color elements of the input signal; a signal generating unit for generating a dummy signal for creating the lookup table; and a tone correction unit for performing tone correction of the dummy signal.

In the image processing circuit of the present invention, since tone correction of the input signal is performed based on the created LUT, there is no need for redundant computational processing for input signals that are the same, and the power consumption of the image processing circuit can be reduced.

Other characteristics, elements, steps, advantages, and properties of the present invention will become clear from the following detailed description of preferred embodiments, and the accompanying drawings.

### BRIEF DESCRIPTION OF THE DRAWINGS

FIG. 1 is a view showing the image processing circuit according to a first embodiment of the present invention;

FIG. 2 is a schematic view showing a display device connected to the image processing circuit of the present invention;

FIG. 3 is a view showing gamma correction in the present invention;

FIG. 4 is a view showing the gamma correction LUT in the present invention;

FIG. 5 is a timing chart for the image processing circuit according to the first embodiment of the present invention;

FIG. 6 is a view showing the image processing circuit according to a second embodiment of the present invention;

FIG. 7 is a view showing contrast adjustment in the present invention;

FIG. 8 is a view showing brightness adjustment in the present invention;

FIG. 9 is a timing chart for RAM writing in the image processing circuit according to the second embodiment of the present invention;

FIG. 10 is a timing chart for RAM reading in the image processing circuit according to the second embodiment of the present invention; and

FIG. 11 is a view showing a conventional image processing circuit.

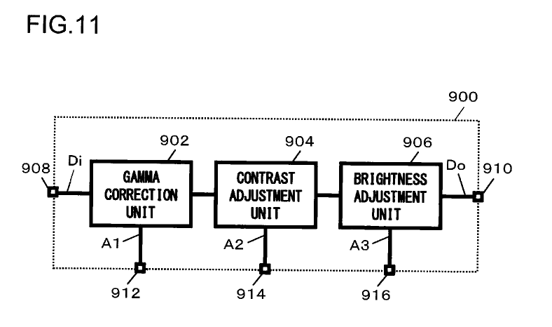

### DETAILED DESCRIPTION OF PREFERRED EMBODIMENTS

### First Embodiment

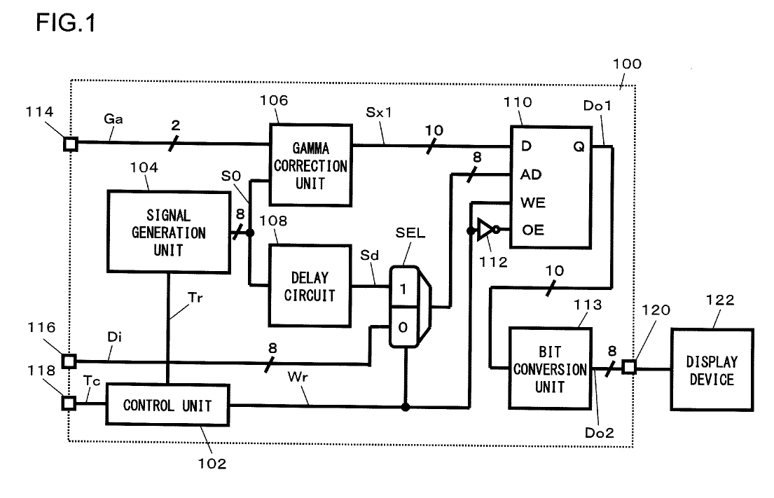

FIG. 1 shows the image processing circuit according to a first embodiment. The image processing circuit 100 is provided with a control unit 102, a signal generation unit 104, a gamma correction unit 106, a delay circuit 108, a RAM 110, an inverter 112, a bit conversion unit 113, a selector SEL, a gamma setting terminal 114, an input terminal 116, a sync terminal 118, and an output terminal 120. A display device 122 is connected to the output terminal 120.

The RAM 110 used as a storage device for storing an LUT is provided with a RAM input terminal D, an address terminal AD, a write enable terminal WE, a read enable terminal OE, and a RAM output terminal Q.

The RAM input terminal D is a terminal for inputting write data to the RAM 110, and the address terminal AD is a terminal for specifying the position (address) of memory to be accessed during data writing or data reading in the RAM 110.

The write enable terminal WE and the read enable terminal OE are terminals for specifying operation of the RAM 110. When the signal inputted to the write enable terminal WE is high, the RAM 110 writes the data inputted to the RAM input terminal D to the memory specified by the address terminal AD, and when the signal inputted to the read enable terminal OE is high, the data stored in the memory specified by the address terminal AD are outputted to the RAM output terminal Q.

An input signal Di is inputted to the input terminal 116. The input signal Di is an RGB signal, for example, in which an R value, a G value, and a B value corresponding to each dot of the display device 122 are arranged in sequence. In the Specification, the R value, G value, and B value of the input signal Di are each described as being 8-bit signals, but the bit numbers of the R value, G value, and B value of the input signal Di are not particularly limited, and various modifications are possible.

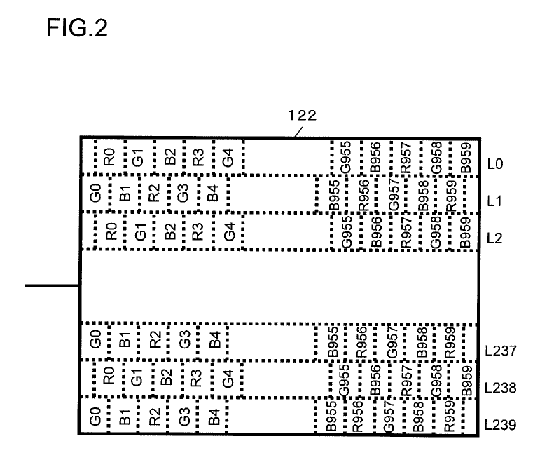

FIG. 2 is a schematic view showing the display device 122. In the display device 122, dots are arranged corresponding to R, G, and B, and when an image is scanned in the display device 122, scanning occurs from the line L0 at the top level. Scanning is performed from dot R0 to dots G1, B2, and so on in sequence to the right in the line L0, and when scanning reaches dot B959, scanning moves to line L1. Scanning is performed from dot G0 to dot R959 in the same manner in line L1 as well, and scanning is performed in the same manner as in line L0 in lines L2, L3, and so on. When scanning reaches dot R959 in the bottom line L239, scanning is repeated from dot R0 of line L0 after a vertical blanking interval of at least 1 microsecond to about 15 microseconds. In the first embodiment, data are written to the RAM 110 during the vertical blanking interval.

The description will again refer to FIG. 1. A vertical sync signal Tc is inputted to the sync terminal 118. The vertical sync signal Tc is a signal for measuring the scan timing per screen in the vertical direction during image scanning in the display device 122. In the first embodiment, scanning to the display device 122 is performed while the vertical sync signal Tc is high, and data writing to the RAM 110 is performed while the vertical sync signal Tc is low (during the vertical blanking interval). When the control unit 102 detects that the vertical sync signal Tc is low and the vertical blanking interval is in effect, the control unit 102 transmits a trigger Tr to the signal generation unit 104 and sets a write signal Wr to high.

When the signal generation unit 104 receives the trigger Tr, the signal generation unit 104 transmits a dummy signal S0 to the delay circuit 108 and the gamma correction unit 106 for performing gamma correction. The dummy signal S0 is a signal for storing an LUT in the RAM 110, and is a signal whereby tone correction is performed by the gamma correction unit 106 instead of the input signal Di in the vertical blanking interval. Since an 8-bit signal is inputted as the input signal Di at this time, the signal generation unit 104 generates signals which increase one level at a time from 0 to 255 as the dummy signal S0 in order to store all of the tone correction results for the input signal Di in the RAM 110.

The gamma correction unit 106 is a tone correction unit for performing tone correction of the dummy signal S0 and outputting a first correction signal Sx1, on the basis of a gamma setting value Ga inputted from the gamma setting terminal 114. The first correction signal Sx1 is inputted to the RAM input terminal D of the RAM 110.

In the gamma correction unit 106, gamma correction is performed as tone correction for the dummy signal S0. Gamma correction is correction processing for enabling an image displayed by the display device 122 to be displayed with the correct brightness or color saturation. The signal inputted to the display device 122 is configured so that the brightness or color of the image is reproduced by adding a predetermined voltage for each dot. However, the brightness or color of the image actually displayed depends on a characteristic (gamma value) of the display device 122, and multiplying the input voltage by some factor does not necessarily increase the brightness of the displayed image by the same factor. Specifically, the relationship is nonlinear, and corrective processing is therefore performed in the gamma correction unit 106 so that the image displayed by the display device 122 is displayed with the correct brightness or color saturation.

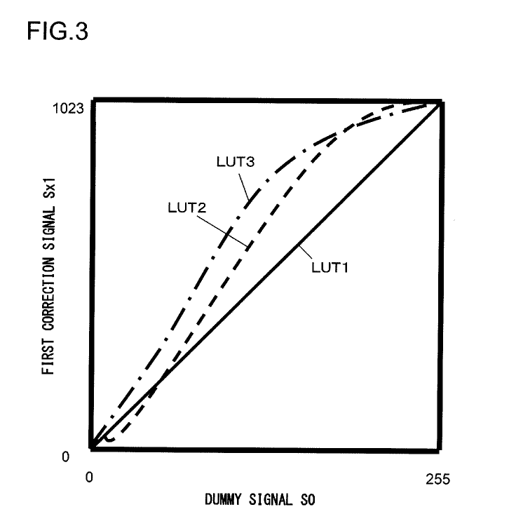

FIG. 3 shows the relationship between input and output of the gamma correction unit 106. The gamma correction unit 106 is provided with a plurality of LUTs which includes an LUT1, an LUT2, and an LUT3, for example, and the LUT which corresponds to the gamma setting value Ga is selected to perform gamma correction of the dummy signal S0. Specifically, the gamma setting value Ga inputted from the gamma setting terminal 114 is a setting value for selecting one LUT from among the plurality thereof provided to the gamma correction unit 106. Processing for increasing the bit number of the signal from 8 bits to 10 bits is also simultaneously performed in the gamma correction unit 106 in order to preserve the accuracy of the first correction signal Sx1, which is the signal after gamma correction.

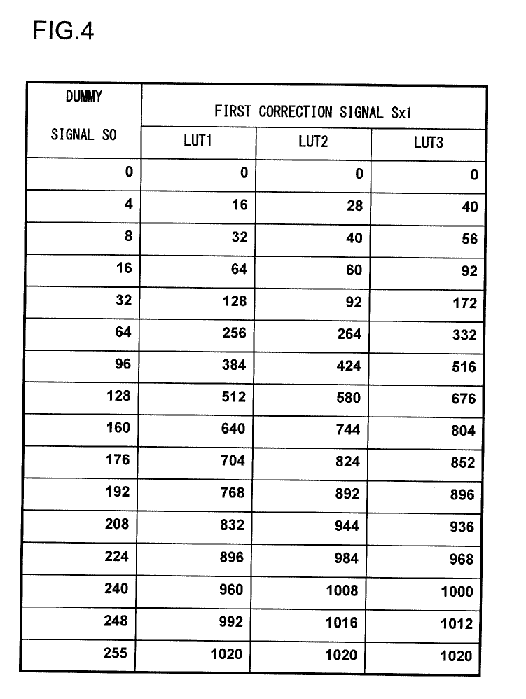

FIG. 4 shows an example of the LUTs provided to the gamma correction unit 106. In gamma correction by the gamma correction unit 106, the LUTs do not necessarily have a correction value corresponding to every value inputted as the dummy signal S0, and as shown in FIG. 4, values for the first correction signal Sx1 corresponding to sixteen dummy signals S0 are maintained, and the rest of the values are linearly interpolated. For example, in a case in which the gamma setting value Ga specifies selection of the LUT1, when 16 is inputted as the dummy signal S0, 64 is outputted as the first correction signal Sx1. When 12 is inputted as the dummy signal S0, 48 is outputted as the first correction signal Sx1 by linear interpolation.

The description will again refer to FIG. 1. The first correction signal Sx1 outputted from the gamma correction unit 106 is inputted to the RAM input terminal D of the RAM 110. At this time, the first correction signal Sx1 is delayed by a predetermined time (e.g., several nanoseconds to several tens of nanoseconds) occurs in by gamma correction in the gamma correction unit 106.

The delay circuit 108 is a circuit for causing a delay in the dummy signal S0 equal to the delay time created by the gamma correction unit 106. The dummy signal S0 inputted to the delay circuit 108 is delayed by several nanoseconds to several tens of nanoseconds and inputted as a delay signal Sd to a second input of the selector SEL.

The selector SEL is a circuit for selecting and outputting one of a plurality of input signals. A first input is outputted when the write signal Wr is low, and a second input is outputted when the write signal Wr is high. During the vertical blanking interval, since the write signal Wr is high, the selector SEL outputs the delay signal Sd inputted to the second input. The output of the selector SEL is inputted to the address terminal AD of the RAM 110.

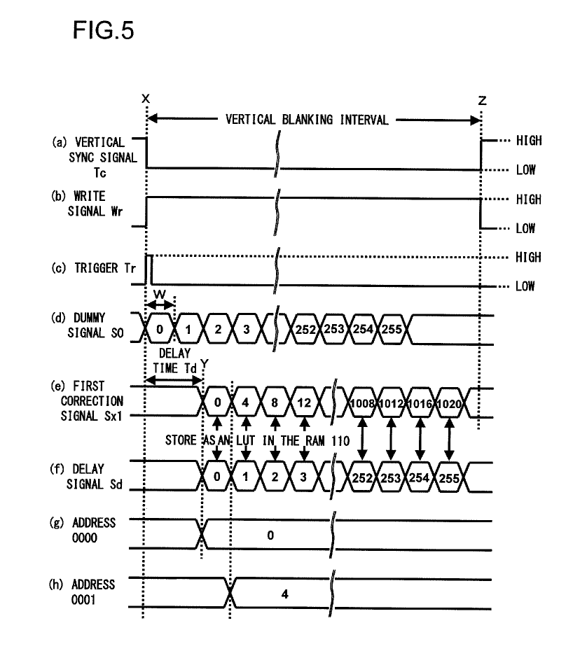

Specifically, while the control unit 102 has set the write signal Wr to high, the first correction signal Sx1 is inputted to the RAM input terminal D of the RAM 110, and the delay signal Sd is inputted to the address terminal AD. Gamma correction results corresponding to all of the possible values of the input signal Di are thereby written to the RAM 110 while the vertical sync signal Tc is low. A timing chart for the signals of each component during writing of data to the RAM 110 is shown in FIG. 5.

FIG. 5 is a timing chart showing the change in the signals of each component of the image processing circuit 100 during writing of data to the RAM 110. The vertical sync signal Tc is shown in (a), the write signal Wr in (b), the trigger Tr in (c), the dummy signal S0 in (d), the first correction signal Sx1 in (e), the delay signal Sd in (f), the state of address 0000 of the RAM 110 in (g), and the state of address 0001 of the RAM 110 in (h).

Data are written to the RAM 110 while the vertical sync signal Tc shown in FIG. 5(a) is low (during the vertical blanking interval). The start time of the vertical blanking interval herein is designated as time X, and the end time of the vertical blanking interval is designated as time Z.

The write signal Wr shown in FIG. 5(b) is a signal for enabling data writing to the RAM 110. While the vertical sync signal Tc is high, the write signal Wr is low, and while the vertical sync signal Tc is low, the write signal Wr is high. FIG. 5(c) shows the trigger Tr. A pulse occurs in the trigger Tr at the timing at which the vertical sync signal Tc changes to low.

The dummy signal S0 is shown in FIG. 5(d). At time X, the signal generation unit 104 generates the dummy signal S0 in conjunction with receiving the trigger Tr. The dummy signal S0 is a signal which starts from 0 and increases one level at a time to the maximum tone of the input signal Di for each predetermined pulse width W (e.g., 10 nanoseconds to 100 nanoseconds). Since the input signal Di at this time is 8-bit, the dummy signal S0 has values from 0 to 255. The dummy signal S0 is inputted to the gamma correction unit 106 and the delay circuit 108.

The first correction signal Sx1 is shown in FIG. 5(e). Gamma correction is performed for the dummy signal S0 by the gamma correction unit 106, and the gamma correction results are outputted as the first correction signal Sx1. At this time, a delay time Td occurs in the first correction signal Sx1. In FIG. 5, the tone correction results corresponding to the values 0, 1, 2, and 3 in the dummy signal S0 are outputted as values of 0, 4, 8, and 12 in the first correction signal Sx1.

FIG. 5(f) shows the delay signal Sd. The dummy signal S0, the value of which remains unchanged, is delayed in phase by the delay time Td and outputted as the delay signal Sd by the delay circuit 108.

At this time, the first correction signal Sx1 is inputted to the RAM input terminal D of the RAM 110, and the delay signal Sd is inputted to the address terminal AD of the RAM 110. Specifically, gamma correction results corresponding to values from 0 to 255 are stored as an LUT in the RAM 110. For example, as shown in FIG. 5(g), when the delay signal Sd is zero, a zero, which is the value of the first correction signal Sx1 at that time, is written to address block number 0000 of the RAM 110. As shown in FIG. 5(h), 4 as the value of the first correction signal Sx1 at that time is written to address block number 0001 of the RAM 110 when the delay signal Sd is 1.

All of the tone correction results are stored in the RAM 110 during the vertical blanking interval. At time Z when the vertical blanking interval is ended, the control unit 102 sets the write signal Wr to low.

The description will again refer to FIG. 1. When data writing to the RAM 110 is completed, and the vertical blanking interval ends, the control unit 102 sets the write signal Wr to low, and the input signal Di is inputted from the input terminal 116.

The input signal Di is inputted to the first input of the selector SEL. Since the write signal Wr is low at this time, the selector SEL outputs the first input. The output of the selector SEL is inputted to the address terminal AD of the RAM 110.

The write signal Wr is inputted to the read enable terminal OE of the RAM 110 via the inverter 112. Specifically, during the period other than the vertical blanking interval, the RAM 110 operates in a read mode for outputting from the RAM output terminal Q the data which were written to the address inputted to the address terminal AD. Since gamma correction results corresponding to values from 0 to 255 are stored as an LUT in the RAM 110 in the vertical blanking interval, gamma correction is performed indirectly for the input signal Di by referencing the LUT in the RAM 110, and the gamma-corrected signal is outputted as a RAM output signal Do1 from the RAM output terminal Q.

The RAM output signal Do1 is inputted to the bit conversion unit 113. The bit conversion unit 113 bit-converts the inputted 10-bit RAM output signal Do1 to a bit number suitable for the display device 122.

Since the input signal Di at this time is converted from 8 bits to 10 bits in the gamma correction by the RAM 110, the bit conversion unit 113 converts the 10-bit RAM output signal Do1 to 8 bits. The conversion from 10 bits to 8 bits may be performed by truncating the lower two bits of the RAM output signal Do1, or by publicly known dithering processing.

A first embodiment is described above. Through this configuration, gamma correction results corresponding to all of the possible values inputted as the input signal Di are stored as an LUT in the RAM 110 during the vertical blanking interval, and after the vertical blanking interval is ended, gamma correction of the input signal Di is performed by referencing the LUT. Since computational processing for gamma correction can therefore be performed 256 times in the case of an 8-bit signal, and there is no redundant computational processing, the power consumption of the image processing circuit 100 can be reduced.

### Second Embodiment

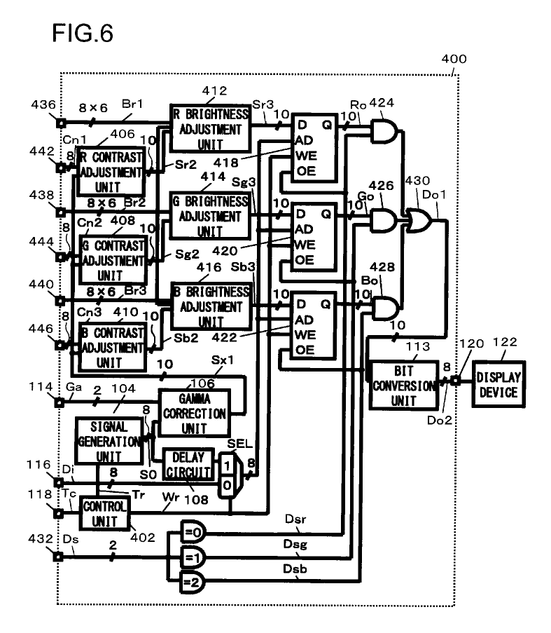

FIG. 6 shows the image processing circuit according to a second embodiment. The image processing circuit 400 differs significantly from the image processing circuit 100 shown in FIG. 1 in that a RAM storage device for storing an LUT is provided independently for each primary-color element of the input signal Di, i.e., for each of R values, G values, and B values. The same reference symbols are used for components which are the same as those in FIG. 1, and no detailed description thereof will be given.

The image processing circuit 400 is provided with a control unit 402, a signal generating unit 104, a gamma correction unit 106, an R contrast adjustment unit 406, a G contrast adjustment unit 408, a B contrast adjustment unit 410, an R brightness adjustment unit 412, a G brightness adjustment unit 414, a B brightness adjustment unit 416, an R RAM 418, a G RAM 420, a B RAM 422, a delay circuit 108, a selector SEL, and a bit conversion unit 113.

The image processing circuit 400 is further provided with a first AND circuit 424, a second AND circuit 426, a third AND circuit 428, an OR circuit 430, an input terminal 116, a sync terminal 118, an identification terminal 432, a gamma setting terminal 114, an R brightness setting terminal 436, a G brightness setting terminal 438, a B brightness setting terminal 440, an R contrast setting terminal 442, a G contrast setting terminal 444, a B contrast setting terminal 446, and an output terminal 120. A display device 122 is connected to the output terminal 120.

An input signal Di is inputted to the input terminal 116. The input signal Di is an RGB signal, for example, in which an R value, a G value, and a B value corresponding to each dot of the display device 122 are arranged in sequence. In the present Specification, the R value, G value, and B value of the input signal Di are each described as being 8-bit signals, but the bit numbers of the R value, G value, and B value are not particularly limited, and various modifications are possible.

A vertical sync signal Tc is inputted to the sync terminal 118. The vertical sync signal Tc is a signal for synchronizing the vertical direction during scanning of an image in the display device 122. In the second embodiment, scanning to the display device 122 is performed while the vertical sync signal Tc is high, and the R RAM 418, G RAM 420, and B RAM 422 are updated while the vertical sync signal Tc is low (during the vertical blanking interval). When the control unit 402 detects that the vertical sync signal Tc is low and the vertical blanking interval is in effect, the control unit 402 transmits a trigger Tr to the signal generation unit 104 and sets a write signal Wr to high.

When the signal generation unit 104 receives the trigger Tr, the signal generation unit 104 transmits a dummy signal S0 to the delay circuit 108 and the gamma correction unit 106. Since the input signal Di is an 8-bit signal at this time, the signal generation unit 104 generates signals which increase one level at a time from 0 to 255 in order to store all of the tone correction results for the input signal Di in the R RAM 418, the G RAM 420, and the B RAM 422.

The gamma correction unit 106 performs gamma correction for the dummy signal S0 on the basis of a gamma setting value Ga inputted from the gamma setting terminal 114, and outputs the gamma correction results as a first correction signal Sx1 to the R contrast adjustment unit 406, the G contrast adjustment unit 408, and the B contrast adjustment unit 410. The gamma correction performed by the gamma correction unit 106 is the same as in the first embodiment. The gamma correction unit 106 is a joint tone correction unit for performing tone correction in common for R values, G values, and B values.

The first correction signal Sx1 outputted from the gamma correction unit 106 is inputted to the R contrast adjustment unit 406, the G contrast adjustment unit 408, and the B contrast adjustment unit 410. The contrast adjustment units perform contrast adjustment of the first correction signal Sx1 on the basis of an R brightness setting value Br1, a G brightness setting value Br2, and a B brightness setting value Br3 inputted from the R contrast setting terminal 442, the G contrast setting terminal 444, and the B contrast setting terminal 446, respectively, and output the results as second correction signals Sr2, Sg2, Sb2. The R contrast adjustment unit 406, the G contrast adjustment unit 408, and the B contrast adjustment unit 410 are individual tone correction units for performing tone correction independently for R, G, and B.

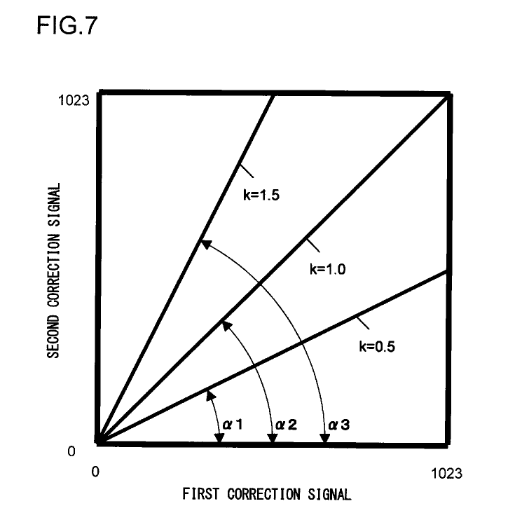

FIG. 7 shows the relationship between input and output of each contrast adjustment unit. Each contrast adjustment unit performs processing for multiplying the first correction signal Sx1 by a coefficient k which is set by each contrast setting terminal. The coefficient k is set independently for R, G, and B by the R brightness setting value Br1, the G brightness setting value Br2, and the B brightness setting value Br3. For example, in a case in which the value of the coefficient k is larger than 1, the slope α3 of the graph as shown at k=1.5 in FIG. 7 is greater than the slope α2 when k=1.0, and when the value of the coefficient k is less than 1, the slope α1 of the graph as shown at k=0.5 in FIG. 7 is less than the slope α2. Computation results equal to or greater than 1024 are clipped.

The description will again refer to FIG. 6. The second correction signals Sr2, Sg2, Sb2 are inputted to the R brightness adjustment unit 412, the G brightness adjustment unit 414, and the B brightness adjustment unit 416, respectively. Fine tone adjustment is performed independently for R, G, and B in the brightness adjustment units.

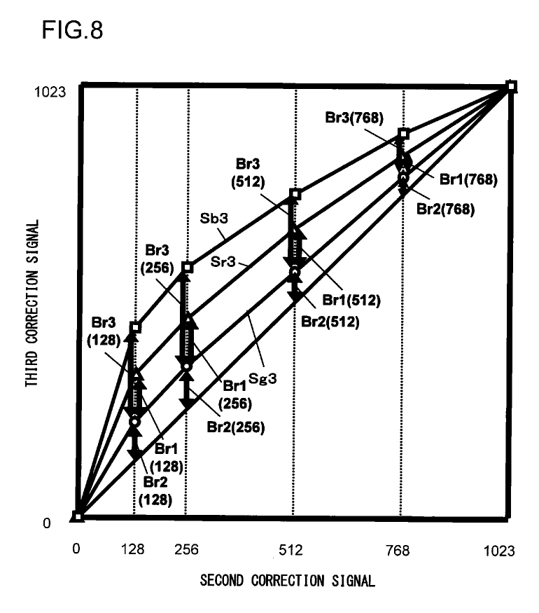

FIG. 8 shows the relationship between input and output of each brightness adjustment unit. The second correction signals Sr2, Sg2, Sb2, as well as an R brightness setting value Br1, G brightness setting value Br2, and B brightness setting value Br3 which indicate correction values to be added to (or subtracted from) the second correction signals Sr2, Sg2, Sb2 are inputted from the R brightness setting terminal 436, G brightness setting terminal 438, and first differential amplifying circuit 40, respectively, at the times of pre-set input correction points (e.g., 0, 128, 256, 512, 768, and 1024). For example, by the G brightness setting value Br2, six correction values are set from the Br2 (0) which is the correction value when the second correction signal Sg2 is 0 to the Br2 (1023) which is the correction value when the second correction signal Sg2 is 1023. Linear interpolation is performed when the second correction signals Sr2, Sg2, Sb2 are not at the input correction points. For example, the correction value Br2 (192) when the second correction signal Sg2 is at 192 is set to the middle value between the correction value Br2 (128) at input correction point 128 and the correction value Br2 (256) at input correction point 256.

For correction of the second correction signal Sr2 indicating the R value and the second correction signal Sb2 indicating the B value, using the G brightness setting value Br2 as a reference, the difference with respect to the G brightness setting value Br2 is set as the R brightness setting value Br1 and the B brightness setting value Br3. It is thereby possible to perform tone correction of RGB values based on the G brightness setting value Br2. When the second correction signal is at point 128, for example, the third correction signals Sr3, Sg3, Sb3 are given by the following equations.

Third correction signal Sr3(128)=Second correction signal Sr2+Br2(128)+Br1(128)

Third correction signal Sg3(128)=Second correction signal Sg2+Br2(128)

Third correction signal Sb3(128)=Second correction signal Sb2+Br2(128)+Br3(128) [Eq. 1]

The description will again refer to FIG. 6. The third correction signals Sr3, Sg3, Sb3 outputted from the R brightness adjustment unit 412, G brightness adjustment unit 414, and B brightness adjustment unit 416 are inputted to the RAM input terminals D of the R RAM 418, the G RAM 420, and the B RAM 422, respectively.

At this time, the third correction signals Sr3, Sg3, Sb3 are delayed by a predetermined time (e.g., several nanoseconds to several tens of nanoseconds) in relation to the dummy signal S0 due to tone correction in the gamma correction unit 106, the contrast adjustment units, and the brightness adjustment units.

The delay circuit 108 is a circuit for delaying the dummy signal S0 by the same amount of time as the delay time that occurs in the gamma correction unit 106, the contrast adjustment units, and the brightness adjustment units. The dummy signal S0 inputted to the delay circuit 108 is delayed by several nanoseconds to several tens of nanoseconds and inputted as a delay signal Sd to the second input of the selector SEL.

The selector SEL is a circuit for selecting and outputting one of a plurality of input signals. Since the write signal Wr is high, the selector SEL outputs the delay signal Sd inputted to the second input. The output of the selector SEL is inputted to the address terminals AD of the R RAM 418, the G RAM 420, and the B RAM 422.

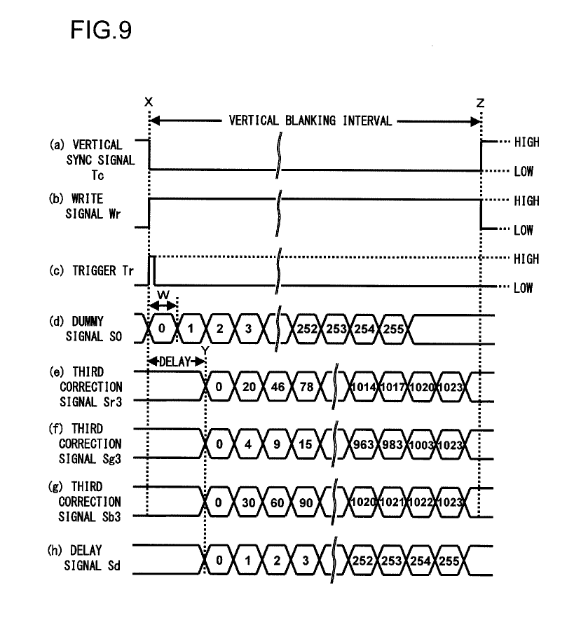

Specifically, while the control unit 402 has set the write signal Wr to high, the third correction signals Sr3, Sg3, Sb3 are inputted to the RAM input terminals D of the R RAM 418, the G RAM 420, and the B RAM 422, respectively, and the delay signal Sd is inputted to the address terminals AD. Gamma correction results corresponding to all of the possible values of the input signal Di are thereby written to the R RAM 418, the G RAM 420, and the B RAM 422 independently for R, G, and B while the vertical sync signal Tc is low. A timing chart for the signals of each component during writing of data to each RAM is shown in FIG. 9.

FIG. 9 is a timing chart showing the change in the signals of each component of the image processing circuit 400 during writing of data to the R RAM 418, the G RAM 420, and the B RAM 422. The vertical sync signal Tc is shown in (a), the write signal Wr in (b), the trigger Tr in (c), the dummy signal S0 in (d), the third correction signal Sr3 in (e), the third correction signal Sg3 in (f), the third correction signal Sb3 in (g), and the delay signal Sd in (h).

The vertical sync signal Tc is shown in FIG. 9(a). Data are written to the R RAM 418, the G RAM 420, and the B RAM 422 while the vertical sync signal Tc is low (during the vertical blanking interval). The start time of the vertical blanking interval herein is designated as time X, and the end time of the vertical blanking interval is designated as time Z.

The write signal Wr is shown in FIG. 9(b). The write signal Wr is a signal for enabling data writing to the R RAM 418, the G RAM 420, and the B RAM 422. While the vertical sync signal Tc is high, the write signal Wr is low, and while the vertical sync signal Tc is low, the write signal Wr is high. FIG. 9(c) shows the trigger Tr. A pulse occurs in the trigger Tr at the timing at which the vertical sync signal Tc changes to low.

The dummy signal S0 is shown in FIG. 9(d). At time X, the signal generation unit 104 generates the dummy signal S0 in conjunction with receiving the trigger Tr. The dummy signal S0 is a signal which starts from 0 and increases one level at a time to the maximum tone of the input signal Di for each predetermined pulse width W (e.g., 10 nanoseconds to 100 nanoseconds). Since the input signal Di at this time is 8-bit, the dummy signal S0 has values from 0 to 255. The dummy signal S0 is inputted to the gamma correction unit 106 and the delay circuit 108.

The third correction signal Sr3 is shown in FIG. 9(e). Tone correction is performed for the dummy signal S0 in the gamma correction unit 106, the R contrast adjustment unit 406, and the R brightness adjustment unit 412, and the tone correction results are outputted as the third correction signal Sr3. At this time, the third correction signal Sr3 is delayed by a delay time Td in relation to the dummy signal S0. In FIG. 9, the tone correction results corresponding to the values 0, 1, 2, 3, and so on in the dummy signal S0 are outputted as values of 0, 20, 46, 78, and so on in the third correction signal Sr3.

The third correction signal Sg3 is shown in FIG. 9(f). Tone correction is performed for the dummy signal S0 in the gamma correction unit 106, the G contrast adjustment unit 408, and the G brightness adjustment unit 414, and the tone correction results are outputted as the third correction signal Sg3. At this time, the third correction signal Sg3 is delayed by a delay time Td in relation to the dummy signal S0. In FIG. 9, the tone correction results corresponding to the values 0, 1, 2, 3, and so on in the dummy signal S0 are outputted as values of 0, 4, 9, 15, and so on in the third correction signal Sg3.

The third correction signal Sb3 is shown in FIG. 9(g). Tone correction is performed for the dummy signal S0 in the gamma correction unit 106, the B contrast adjustment unit 410, and the B brightness adjustment unit 416, and the tone correction results are outputted as the third correction signal Sb3. At this time, the third correction signal Sb3 is delayed by a delay time Td in relation to the dummy signal S0. In FIG. 9, the tone correction results corresponding to the values 0, 1, 2, 3, and so on in the dummy signal S0 are outputted as values of 0, 30, 60, 90, and so on in the third correction signal Sb3.

FIG. 9(h) shows the delay signal Sd. The dummy signal S0, the value of which remains unchanged, is delayed in phase by the delay time Td and outputted as the delay signal Sd by the delay circuit 108.

At this time, the third correction signals Sr3, Sg3, Sb3 are inputted separately to the RAM input terminals D of the R RAM 418, G RAM 420, and B RAM 422, respectively, and the delay signal Sd is inputted to the address terminals AD of the R RAM 418, the G RAM 420, and the B RAM 422. Specifically, tone correction results corresponding to values from 0 to 255 are stored as an LUT independently for R, G, and B in the R RAM 418, the G RAM 420, and the B RAM 422.

All of the tone correction results are stored in the R RAM 418, G RAM 420, and B RAM 422 during the vertical blanking interval. At time Z when the vertical blanking interval is ended, the control unit 102 sets the write signal Wr to low.

The description will again refer to FIG. 6. When data writing to the R RAM 418, G RAM 420, and B RAM 422 is completed, and the vertical blanking interval ends, the control unit 402 sets the write signal Wr to low, the input signal Di is inputted from the input terminal 116, and an identification signal Ds is inputted from the identification terminal 432.

The identification signal Ds is a signal for identifying which of an R value, a G value, or a B value is indicated by the input signal Di inputted from the input terminal 116. Since an R value, a G value, and a B value are inputted in sequence as an input signal Di for each dot of the display device 122, the identification signal Ds is generated by a ternary counter synchronized with the input signal Di, for example.

The R selection signal Dsr is high when the identification signal Ds is 0, the G selection signal Dsg is high when the identification signal Ds is 1, and the B selection signal Dsb is high when the identification signal Ds is 2.

The R selection signal Dsr is inputted to the first AND circuit 424 and to the read enable terminal OE of the R RAM 418, the G selection signal Dsg is inputted to the second AND circuit 426 and to the read enable terminal OE of the G RAM 420, and the B selection signal Dsb is inputted to the third AND circuit 428 and to the read enable terminal OE of the B RAM 422.

The input signal Di is inputted to the first input of the selector SEL. Since the write signal Wr is low at this time, the selector SEL outputs the first input. The output of the selector SEL is inputted to the address terminals AD of the R RAM 418, G RAM 420, and B RAM 422.

Specifically, during the period other than the vertical blanking interval, the R RAM 418, G RAM 420, and B RAM 422 operate in a read mode for outputting from the RAM output terminal Q the data which were written to the address inputted to the address terminals AD. Since gamma correction results corresponding to values from 0 to 255 are stored as an LUT in each RAM in the vertical blanking interval, gamma correction is performed indirectly for the input signal Di by referencing the LUT in each RAM.

The outputs of the R RAM 418, G RAM 420, and B RAM 422 are inputted to the first AND circuit 424, second AND circuit 426, and third AND circuit 428, respectively, and the output of each AND circuit is inputted to the OR circuit 430. The signals tone-corrected independently for R, G, and B are thereby synthesized to be outputted as a single RAM output signal Do1 from the OR circuit 430.

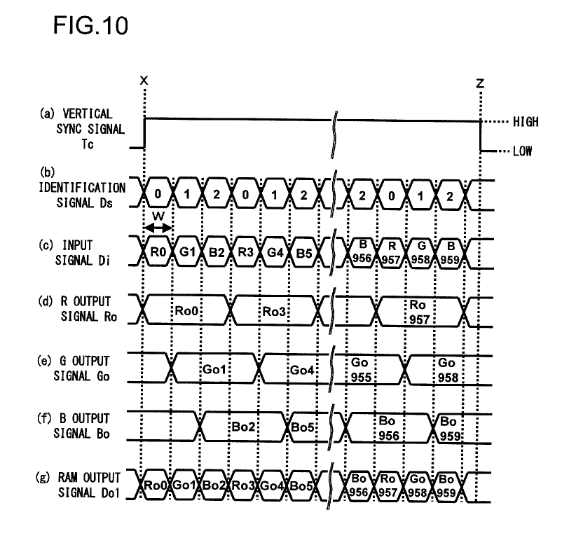

FIG. 10 is a timing chart showing the change in the signals of each component of the image processing circuit 400 during reading of data from the R RAM 418, the G RAM 420, and the B RAM 422. The vertical sync signal Tc is shown in (a), the identification signal Ds in (b), the input signal Di in (c), the R output signal Ro in (d), the G output signal Go in (e), the B output signal Bo in (f), and the RAM output signal Do1 in (g).

While the vertical sync signal Tc shown in FIG. 10(a) is high, the input signal Di is inputted from the input terminal 116. The input signal Di is inputted to the first input of the selector SEL. Since the write signal Wr is low at this time, the selector SEL outputs the first input. The output of the selector SEL is inputted to the address terminals AD of the R RAM 418, G RAM 420, and B RAM 422.

The identification signal Ds shown in FIG. 10(b) is a signal for identifying which of an R value, a G value, or a B value is indicated by the data inputted as the input signal Di. In synchronization with the input signal Di, the value of the identification signal Ds is 0 to indicate that the input signal Di is an R value, 1 to indicate that the input signal Di is a G value, and 2 to indicate that the input signal Di is a B value.

The input signal Di shown in FIG. 10(c) is a signal in which R values, G values, and B values corresponding to each dot of the display device 122 are arranged in sequence for each predetermined pulse width W (e.g., 10 nanoseconds to 100 nanoseconds).

The R output signal Ro is shown in FIG. 10(d). For example, the value of R0 in the input signal Di is inputted to the address terminal AD of the R RAM 418, whereby tone correction is indirectly performed, and Ro0 as the tone correction result for R0 is outputted from the output terminal Q. In the same manner, when the value of R3 is inputted to the address terminal AD of the R RAM 418, Ro3 as the tone correction result for R3 is outputted from the output terminal Q.

The G output signal Go is shown in FIG. 10(e). For example, the value of G1 in the input signal Di is inputted to the address terminal AD of the G RAM 420, whereby tone correction is indirectly performed, and Go1 as the tone correction result for G1 is outputted from the output terminal Q. In the same manner, when the value of G4 is inputted to the address terminal AD of the G RAM 420, Go4 as the tone correction result for G4 is outputted from the output terminal Q.

The B output signal Bo is shown in FIG. 10(f). For example, the value of B2 in the input signal Di is inputted to the address terminal AD of the B RAM 422, whereby tone correction is indirectly performed, and Bot as the tone correction result for B2 is outputted from the output terminal Q. In the same manner, when the value of B5 is inputted to the address terminal AD of the B RAM 422, Bo5 as the tone correction result for B5 is outputted from the output terminal Q.

The RAM output signal Do1 is shown in FIG. 10(g). In the second embodiment, the RAM output signal Do1 is a signal in which the R output signal Ro, G output signal Go, and B output signal Bo are synthesized. The R output signal Ro, G output signal Go, and B output signal Bo are synthesized into the RAM output signal Do1 by logical processing by the first AND circuit 424, the second AND circuit 426, the third AND circuit 428, and the OR circuit 430. Specifically, when the identification signal Ds is 0, the R output signal Ro is outputted as the RAM output signal Do1; when the identification signal Ds is 1, the G output signal Go is outputted as the RAM output signal Do1; and when the identification signal Ds is 2, the B output signal Bo is outputted. Tone correction results corresponding to R0, G1, B2, and so on in the input signal Di are thereby outputted as Ro0, Go1, Bo2, and so on.

The description will again refer to FIG. 6. The RAM output signal Do1 is inputted to the bit conversion unit 113. The bit conversion unit 113 bit-converts the inputted 10-bit RAM output signal Do1 to a bit number suitable for the display device 122.

Since the input signal Di at this time is converted from 8 bits to 10 bits in the tone correction by the R RAM 418, G RAM 420, and B RAM 422, the bit conversion unit 113 converts the 10-bit RAM output signal Do1 to 8 bits. The conversion from 10 bits to 8 bits may be performed by truncating the lower two bits of the RAM output signal Do1, or by publicly known dithering processing.

A second embodiment is described above. Through this configuration, tone correction results corresponding to all of the possible values inputted as the input signal Di are stored as an LUT in the R RAM 418, G RAM 420, and B RAM 422 during the vertical blanking interval, and gamma correction of the input signal Di is performed by referencing the LUT. Since computational processing for gamma correction can therefore be performed 768 times in the case of an 8-bit signal, and there is no redundant computational processing, the current consumption of the image processing circuit 400 can be reduced. According to measurements by the inventors, a 5 mA to 30 mA reduction in current consumption is possible.

In comparison with the first embodiment, by providing RAM for LUT storage independently for R, G, and B, tone correction can be performed independently for R, G, and B, and more detailed tone correction of the input signal Di is possible.

In the first and second embodiments, the relationship of high and low states between the vertical sync signal Tc, write signal Wr, R selection signal Dsr, G selection signal Dsg, and B selection signal Dsb may be reversed.

In the first and second embodiments, a configuration may be adopted in which registers are connected to the gamma setting terminal 114, the R contrast setting terminal 442, the G contrast setting terminal 444, the B contrast setting terminal 446, the R brightness setting terminal 436, the G brightness setting terminal 438, and the B brightness setting terminal 440, and a setting value is stored in each register.

In the first and second embodiments, the image processing circuits are described as asynchronous circuits, but the image processing circuits may also be configured as synchronous circuits. In this case, the delay circuit 108 may be configured as a circuit for generating a clock delay.

Embodiments of the present invention are described above, but it will be readily apparent to one skilled in the art that the disclosed invention can be modified by various methods, and that various embodiments other than the configurations specifically described are possible. The claims below are therefore intended to encompass all modifications of the present invention within the technical scope thereof in a range which does not deviate from the intent or technical field of the present invention.

What is claimed is:

1. An image processing circuit for performing tone correction of an input signal; said image processing circuit comprising:
a signal generating unit for generating a dummy signal for creating a lookup table;
a tone correction unit for receiving said dummy signal and performing tone correction of said dummy signal; and
a storage device for receiving an output of said tone correction unit and storing the output as a lookup table; wherein
said storage device receives said input signal, references the lookup table stored in said storage device, and performs tone correction of said input signal.

2. The image processing circuit according to claim 1, wherein said storage device is a RAM comprising an input terminal, an address terminal, and a write enable terminal.

3. The image processing circuit according to claim 1, wherein said tone correction unit increases the number of bits of an inputted signal.

4. The image processing circuit according to claim 2, further comprising a delay circuit for receiving said dummy signal and delaying the dummy signal, the output of said delay circuit being inputted to said address terminal.

5. The image processing circuit according to claim 1, wherein said image processing circuit is an image processing circuit used to adjust image quality of a display device, and said lookup table is created in a vertical blanking interval of said display device.

6. The image processing circuit according to claim 3, further comprising a bit conversion unit for reducing the number of bits of an inputted signal in a stage downstream of said storage device.

7. The image processing circuit according to claim 6, wherein said lookup table is stored in a RAM provided with an input terminal, an address terminal, and a write enable terminal.

8. The image processing circuit according to claim 7, wherein
said input signal comprises a plurality of primary-color elements; and
said RAM is provided separately for each of the primary-color elements of said input signal.

9. An image processing circuit for performing tone correction of an input signal, wherein
said input signal comprises a plurality of primary-color elements; and
said image processing circuit comprises:
a plurality of storage devices in which is stored a lookup table for performing tone correction for each of the primary-color elements of said input signal;
a signal generating unit for generating a dummy signal for creating said lookup table; and
a tone correction unit for performing tone correction of said dummy signal.

10. The image processing circuit according to claim 9, wherein said storage device is a RAM provided with an input terminal, an address terminal, and a write enable terminal.

11. The image processing circuit according to claim 10, further comprising a delay circuit for receiving said dummy signal and delaying said dummy signal, the output of said delay circuit being inputted to said address terminal.

12. The image processing circuit according to claim 9, wherein
said tone correction unit comprises:
a joint tone correction unit for performing tone correction jointly for a plurality of primary-color elements; and
an individual tone correction unit for performing tone correction individually for each of the primary-color elements.

13. The image processing circuit according to claim 12, wherein said joint tone correction unit is a gamma correction unit for performing gamma correction of an image.

14. The image processing circuit according to claim 12, wherein said individual tone correction unit is a contrast adjustment unit for performing contrast adjustment of an image.

15. The image processing circuit according to claim 12, wherein at least one of said joint tone correction unit and said individual tone correction unit performs processing for increasing a maximum tone of said input signal.

16. The image processing circuit according to claim 15, further comprising a bit conversion unit for reducing the number of bits of an inputted signal in a stage downstream of said storage device.

17. The image processing circuit according to claim 9, wherein said image processing circuit is an image processing circuit used to adjust image quality of a display device, and said lookup table is updated in a vertical blanking interval of said display device.
